(19) United States
(12) Patent Application Publication
(10) Pub. No.: US 2018/0118160 A1
(43) Pub. Date: May 3, 2018

(54) SINGLE BUTTON ACTIVATION OF ALL VEHICLE SECURITY FUNCTIONS

(71) Applicant: Panasonic Automotive Systems Company of America, Division of Panasonic Corporation of North America, Peachtree City, GA (US)

(72) Inventors: DONALD ALLEN TURNER, SENOIA, GA (US); JERROD WESLEY BRUECKNER, NOVI, MI (US); KURT E. FOSTER, DUBLIN, OH (US); KENTA KIMURA, MARIETTA, GA (US); JODI PAXTON, REDFORD, MI (US); MARIA ROHRER, BLOOMFIELD, MI (US); TODD TUCKER, PEACHTREE CITY, GA (US); JI HYE YEON, ATLANTA, GA (US)

(73) Assignee: Panasonic Automotive Systems Company of America, Division of Panasonic Corporation of North America

(21) Appl. No.: 15/796,459

(22) Filed: Oct. 27, 2017

Related U.S. Application Data
(60) Provisional application No. 62/414,395, filed on Oct. 28, 2016.

(51) Int. Cl. B60R 25/20; H04N 5/232; G08C 17/02; G08B 25/01; G08B 25/10; B60R 25/30; B60R 25/10; B60R 25/104; B60R 25/102; B60R 25/01

(52) U.S. Cl. CPC B60R 25/2018; B60R 2325/205; G08C 17/02; G08B 25/016; G08B 25/10; B60R 25/209; B60R 25/305; B60R 25/1003; B60R 25/104; B60R 25/102; B60R 25/01; G08C 2201/30; G08C 2201/42; B60R 2325/101; B60R 2325/106; H04N 5/23203

(57) ABSTRACT

A motor vehicle includes a plurality of security devices and an electronic processor communicatively coupled to each of the security devices. The electronic processor determines that a user of the motor vehicle has depressed a predetermined pushbutton. In response to determining that the predetermined pushbutton has been depressed, the electronic processor causes each if the security devices to be turned ON.

### CROSS-REFERENCED TO RELATED APPLICATIONS

This application claims benefit of U.S. Provisional Application No. 62/414,395, filed on Oct. 28, 2016, by reference in its entirety for all purposes.

### BACKGROUND OF THE INVENTION

### 1. Field of the Invention

The present invention relates to activating security functions in a motor vehicle.

### 2. Description of the Related Art

Current systems require the vehicle user to activate each security function separately.

### SUMMARY OF THE INVENTION

The invention may provide the operator with the ability to activate all security functions with the push of one button, significantly improving the response time to a security threat. The invention may provide a single button in the interior of a vehicle which enables the operator to activate all functions of the vehicle that improve occupant and/or property security. Such security functions may include, but are not limited to, security camera viewing and/or recording functions for the interior or exterior of the vehicle; audible and/or visual warnings for the exterior of the vehicle; closure of all windows and roof panels; closure of all power sliding doors and lift gates; and locking of all doors.

The invention comprises, in one form thereof, a motor vehicle including a plurality of security devices and an electronic processor communicatively coupled to each of the security devices. The electronic processor determines that a user of the motor vehicle has depressed a predetermined pushbutton. In response to determining that the predetermined pushbutton has been depressed, the electronic processor causes each of the security devices to be turned ON.

The invention comprises, in another form thereof, a method of operating a motor vehicle, including providing a plurality of security devices. It is determined that a user of the motor vehicle has depressed a predetermined pushbutton. In response to determining that the predetermined pushbutton has been depressed, each of the security devices are caused to be turned ON.

The invention comprises, in yet another form thereof, a motor vehicle including a motor vehicle having a plurality of security devices, a manually actuatable device, and an electronic processor communicatively coupled to the manually actuatable device and to each of the security devices. The electronic processor determines that a user of the motor vehicle has actuated the manually actuatable device. In response to determining that the manually actuatable device has been actuated, the electronic processor causes each of the security devices to be turned ON.

An advantage of the invention is that it may reduce the time required for the operator to activate all security functions as compared to having to activate functions individually.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic diagram illustrating one embodiment of a motor vehicle and its security functions.

FIG. 2 is a block diagram of one embodiment of a vehicle security arrangement of the present invention.

FIG. 3 is a block diagram of another embodiment of a vehicle security arrangement of the present invention.

FIG. 4 is a flow chart of one embodiment of a method of the present invention for operating a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

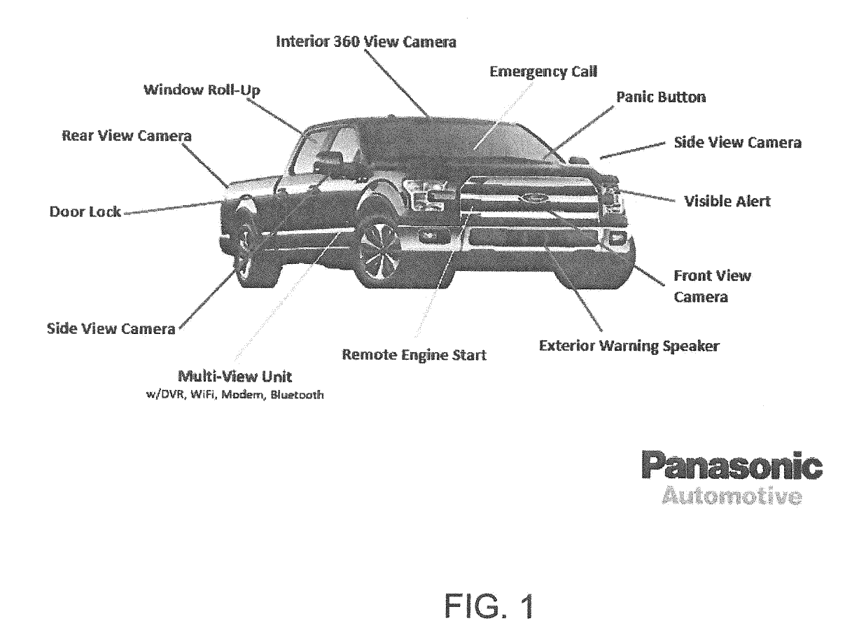

FIG. 1 illustrates one embodiment of a motor vehicle and its example security functions, including emergency telephone call; panic pushbutton; side view cameras; visible alert; front view camera; exterior warning loudspeaker; remote engine starter; multi-view unit with DVR, WiFi, modem, Bluetooth; door lock; rear view camera; window roll-up; and interior 360-degree view camera.

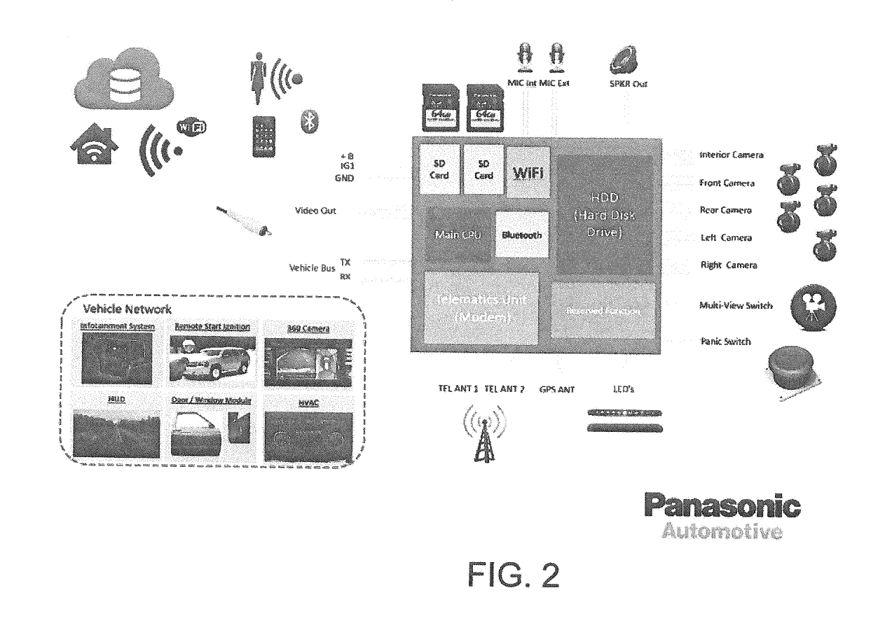

FIG. 2 illustrates one embodiment of a vehicle security arrangement of the present invention including a central controller having SD cards, a WiFi module, a hard disk drive, a telematics unit or modem, a computer processing unit (CPU), and a Bluetooth module. The central controller drives a plurality of security devices, and may turn ON the security devices in response to a user pressing a pushbutton on a smart phone, as detected via the Bluetooth module, or a pushbutton on a computer keyboard, as detected via the WiFi module.

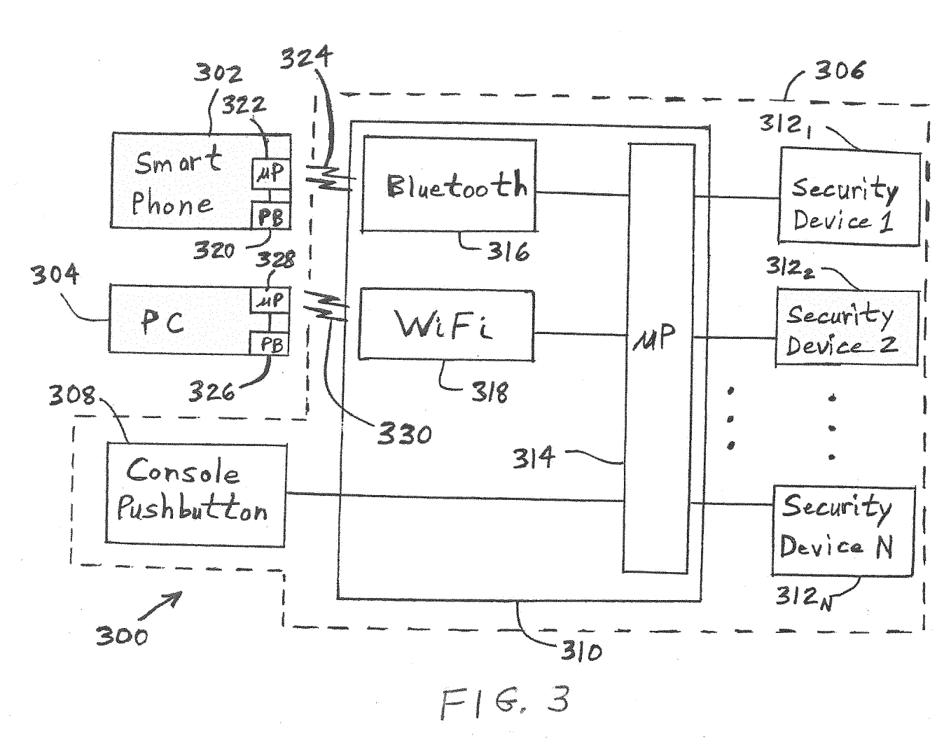

FIG. 3 illustrates another embodiment of a vehicle security arrangement 300 of the present invention including a smart phone 302, personal computer 304, and motor vehicle 306. Motor vehicle 306 includes a manually actuatable device in the form of a pushbutton 308, which may be disposed on the center console in the passenger compartment of vehicle 306. Motor vehicle 306 also includes a security controller 310 and security devices 312₁, 312₂, . . . , 312_{N}. Security controller 310 includes an electronic processor 314 communicatively coupled to a Bluetooth module 316, a WiFi module 318, console pushbutton 308, and security devices 312₁, 312₂, . . . , 312_{N}.

During use, the user may depress a single pushbutton in order to activate or turn ON all of security devices 312₁, 312₂, . . . , 312_{N}. For example, the user may depress console pushbutton 308, which sends a signal to processor 314. Processor 314, in turn, responds to receipt of the signal indicating the depressing of pushbutton 308 by activating or turning ON all of security devices 312₁, 312₂, . . . , 312_{N}.

As another example, the user may depress a pushbutton 320 on smartphone 302, which sends a signal to an electronic processor 322 within smartphone 302. Processor 322, in turn, responds to receipt of the signal indicating the depressing of pushbutton 320 by transmitting a wireless signal 324 which is received by Bluetooth module 316. Bluetooth module 316 then sends a signal to processor 314. Processor 314, in turn, responds to receipt of the signal indicating the depressing of pushbutton 320 by activating or turning ON all of security devices 312₁, 312₂, . . . , 312_{N}.

As yet another example, the user may depress a pushbutton 326 on a keyboard of personal computer 304, which sends a signal to an electronic processor 328 within PC 304. Processor 328, in turn, responds to receipt of the signal indicating the depressing of pushbutton 326 by transmitting a wireless signal 330 which is received by WiFi module 318. WiFi module 318 then sends a signal to processor 314. Processor 314, in turn, responds to receipt of the signal indicating the depressing of pushbutton 326 by activating or turning ON all of security devices 312₁, 312₂, . . . , 312_{N}.

It is also possible for WiFi module 318 to receive signal 324 transmitted by smartphone 302, and then cause processor 314 to turn ON all of security devices 312₁, 312₂, . . . , 312_{N}.

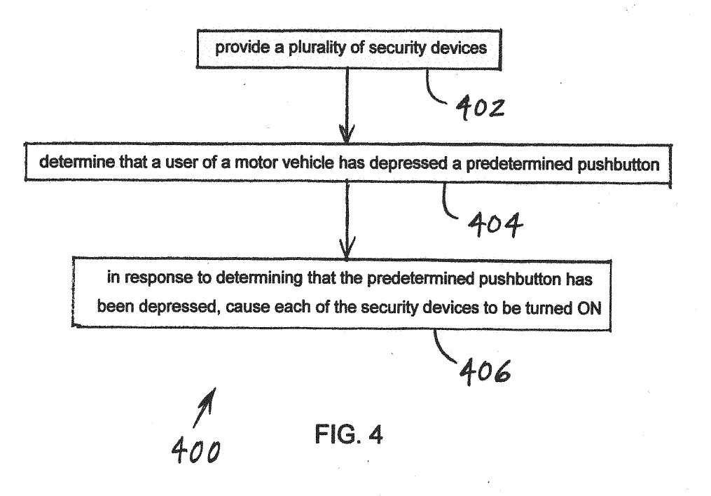

FIG. 4 illustrates one embodiment of a method 400 of the present invention for operating a motor vehicle. In a first step 402, a plurality of security devices are provided in a motor vehicle. For example, as shown in FIG. 1, a vehicle may include a security device for an emergency telephone call, a panic pushbutton, side view cameras, a visible alert, a front view camera, an exterior warning loudspeaker, a remote engine starter, a multi-view unit with DVR, a WiFi module, modem, a Bluetooth module, a door lock module, a rear-view camera, a window roll-up module, and an interior 360-degree view camera.

Next, in step 404 it is determined that a user of the motor vehicle has depressed a predetermined pushbutton. For example, processor 314 may detect a user pressing console pushbutton 308.

In a final step 406, in response to the determining that the predetermined pushbutton has been depressed, each of the security devices is caused to be turned ON. For example, in response to processor 314 detecting a user pressing console pushbutton 308, processor 314 may turn ON security devices 312₁, 312₂, . . . , 312_{N}.

The invention has been described as detecting the user depressing a pushbutton. However, it is to be understood that the scope of the invention may include detecting the user manually operating other types of manually actuatable devices, such as rocker switches, levers, toggle switches, etc.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A motor vehicle, comprising:
a plurality of security devices; and
an electronic processor communicatively coupled to each of the security devices, the electronic processor being configured to:
determine that a user of the motor vehicle has depressed a predetermined pushbutton; and
in response to determining that the predetermined pushbutton has been depressed, cause each of the security devices to be turned ON.

2. The motor vehicle of claim 1, wherein the predetermined pushbutton is on an electronic device that is not attached to the motor vehicle, the motor vehicle further comprising a Bluetooth module communicatively coupled to the electronic processor and configured to:
receive a wireless signal from the electronic device, the wireless signal being indicative of the pushbutton being depressed; and
transmit a notification signal to the electronic processor, the notification signal being indicative of the pushbutton being depressed.

3. The motor vehicle of claim 1, wherein the predetermined pushbutton is on an electronic device that is not attached to the motor vehicle, the motor vehicle further comprising a WiFi module communicatively coupled to the electronic processor and configured to:
receive a wireless signal from the electronic device, the wireless signal being indicative of the pushbutton being depressed; and
transmit a notification signal to the electronic processor, the notification signal being indicative of the pushbutton being depressed.

4. The motor vehicle of claim 1, wherein the plurality of security devices include a camera.

5. The motor vehicle of claim 1, wherein the plurality of security devices include an emergency telephone call device, a panic pushbutton, a visible alert, or an exterior warning loudspeaker.

6. The motor vehicle of claim 1, wherein the plurality of security devices include a remote engine starter or a multi-view unit.

7. The motor vehicle of claim 1, wherein the plurality of security devices include a door lock or a window roll-up device.

8. A method of operating a motor vehicle, the method comprising:
providing a plurality of security devices;
determining that a user of the motor vehicle has depressed a predetermined pushbutton; and
in response to determining that the predetermined pushbutton has been depressed, causing each of the security devices to be turned ON.

9. The method of claim 8, wherein the predetermined pushbutton is on an electronic device that is not attached to the motor vehicle, the method further comprising using a Bluetooth module to receive a wireless signal from the electronic device, the wireless signal being indicative of the pushbutton being depressed.

10. The method of claim 8, wherein the predetermined pushbutton is on an electronic device that is not attached to the motor vehicle, the method further comprising using a WiFi module to receive a wireless signal from the electronic device, the wireless signal being indicative of the pushbutton being depressed.

11. The method of claim 8, wherein the plurality of security devices include a camera.

12. The method of claim 8, wherein the plurality of security devices include an emergency telephone call device, a panic pushbutton, a visible alert, or an exterior warning loudspeaker.

13. The method of claim 8, wherein the plurality of security devices include a remote engine starter or a multi-view unit.

14. The method of claim 8, wherein the plurality of security devices include a door lock or a window roll-up device.

15. A motor vehicle, comprising:
a plurality of security devices;
a manually actuatable device; and
an electronic processor communicatively coupled to the manually actuatable device and to each of the security devices, the electronic processor being configured to:
determine that a user of the motor vehicle has actuated the manually actuatable device; and
in response to determining that the manually actuatable device has been actuated, cause each of the security devices to be turned ON.

16. The motor vehicle of claim 15, wherein the manually actuatable device comprises a pushbutton installed in the motor vehicle.

17. The motor vehicle of claim 15, wherein the plurality of security devices include a camera.

18. The motor vehicle of claim 15, wherein the plurality of security devices include an emergency telephone call device, a panic pushbutton, a visible alert, or an exterior warning loudspeaker.

19. The motor vehicle of claim 15, wherein the plurality of security devices include a remote engine starter or a multi-view unit.

20. The motor vehicle of claim 15, wherein the plurality of security devices include a door lock or a window roll-up device.

21. The method of claim 15, wherein the manually actuatable device is on an electronic device that is disposed within the motor vehicle, the motor vehicle further comprising a Bluetooth module or a WiFi module communicatively coupled to the electronic processor and configured to:
receive a wireless signal from the electronic device, the wireless signal being indicative of the manually actuatable device being actuated; and
transmit a notification signal to the electronic processor, the notification signal being indicative of the pushbutton being actuated.
